(19) United States
(12) Patent Application Publication
(10) Pub. No.: US 2005/0021446 A1
(43) Pub. Date: Jan. 27, 2005

(54) Systems and methods for cache capacity trading across a network

(76) Inventors: Andrew B. Whinston, Austin, TX (US); Ramaswamy Ramesh, East Amherst, NY (US); Ram Gopal, Manchester, CT (US); Xianjun Geng, Shoreline, WA (US)

Correspondence Address: Barry S. Newberger;Winstead Sechrest & Minick P.C., 1201 Main Street, P.O. Box 50784, Dallas, TX, 75250-0784, US

(21) Appl. No.: 10/701,576

(22) Filed: Nov. 5, 2003

Related U.S. Application Data
(60) Provisional application No. 60/424,939, filed on Nov. 8, 2002.
(60) Provisional application No. 60/449,255, filed on Feb. 21, 2003.
(60) Provisional application No. 60/487,367, filed on Jul. 15, 2003.

(51) Int. Cl. G06F 17/60; G06F 15/173

(52) U.S. Cl. 705/37; 709/226

(57) ABSTRACT

A mechanism for trading cache capacity among network nodes, or equivalently, Network Service Providers and Internet Service Providers (collectively XSPs). The mechanism includes determining an arbitrage-free path in a network including at least one node having an excess of cache capacity and at least one node having an excess cache demand. The excess cache capacity on the arbitrage-free path is allocated to a node of the at least one node having an excess cache demand. A trading price is established for the excess cache capacity allocated.

### CROSS REFERENCE TO RELATED APPLICATIONS

This application claims the benefit of priority of the following U.S. Provisional Applications under 35. U.S.C. § 119(e):
Ser. No. 60/424,939, entitled CAPACITY PROVISION NETWORKS: SYSTEMS FOR INTERNET CACHING, filed Nov. 8, 2002;
Ser. No. 60/449,255, entitled CAPACITY PROVISION NETWORKS: SYSTEMS FOR DEMAND-SIDE CACHE TRADING, filed Feb. 21, 2003; and
Ser. No. 60/487,367, entitled TRADING CACHES: CAPACITY PROVISION NETWORKS, filed Jul. 15, 2003.

### TECHNICAL FIELD

The present invention relates to data processing systems and in particular to data processing systems for the trading of cache capacity by any service provider on the Internet.

### BACKGROUND

The World Wide Web (WWW) includes numerous players. Broadly, these can be classified into content providers., content consumers and an array of service providers. The rapid advances in the technologies for digital content distribution have impacted all these players, and increasing opportunities for content creation, distribution and consumption have led to strong externalities in each of these constituencies. While this is desirable from both the points of view of digital businesses and consumers, it is also straining the fundamental infrastructure of the Internet in providing adequate support for digital content delivery. Quality of Service (QoS) at the customers' end is of paramount importance to both content and other service providers, and the network externality effect is not helping them in this dimension. (For a given system that is composed of several members, if all members benefit when a new member joins, this system is said to have positive network externality.) One approach employed by network service providers to attempt to increase their bandwidths and server capacities uses replicated servers with proxies that enable content providers to distribute and bring their content closer to the end users through Content Delivery Networks (CDN). These exploit the idea of Web caching, in which content from origin servers is partially replicated at multiple other servers with a view to reduce traffic in the Internet core and maximize web accesses at the edge of the network.

When multiple users access the same web objects either concurrently or within a short time interval, caching these objects at a common server and feeding the users from this proxy could (i) reduce the bandwidth required to serve these users, (ii) reduce the latencies in accessing the required information, (iii) reduce the overhead in maintaining several TCP connections by the origin servers. Also, when proxies are used as interceptors of a single stream from an origin server and broadcasters to several concurrent users additional significant bandwidth savings and latency reduction in multimedia streaming presentations could be achieved. This suggests an opportunity for all service providers on the Internet to optimally use their cache resources. The resource deployment could assume some form of centralized caches that serve multiple users. Hereinafter, we will refer to such service providers on the Internet as XSPs. Examples of XSPs include Internet Service Providers (ISPs) and Network Service Providers (NSPs). This however, does not solve the capacity problems associated with caching. Presently, the solution to the capacity problem apparently is to increase the bandwidth and storage capacities as required when customer demands increase over time.

This however, is problematic if not an unacceptable solution for many providers. The network externality effect on the customers is mostly a gradual effect; the customer base does not expand overnight. As a result, an XSP needs to predict as far into the future as possible in determining a scalable server configuration, and this is extremely difficult. Even if a scalable configuration is determined, there will be a significant period of under-utilization of the capacity resources as it takes time for the demand to build up to the planned capacity levels. Moreover, users' web access behavior is very uneven. Spikes and troughs in volume access occur frequently, and combined with the variety in web objects accessed pose serious challenges in coordinating cache consistency maintenance policies within an available capacity space. The tradeoff in this regard is clear: increasing capacity would yield greater flexibility in consistency maintenance, but at a significant cost. Third, customer churn rates are closely linked to performance, especially in the XSP market. An anecdotal rule in the Internet community is the eight-second rule: namely, after eight seconds of waiting for a web page to be downloaded, a customer becomes impatient and will likely abandon the site. An increasing frequency of such abandonment leads to poor evaluations of an XSP's performance by a customer who may ultimately decide to seek another service. As a result, churn rates put a premium on performance, especially in uncertain XSP markets.

Thus, an XSP faces strategic planning decisions to ensure capacity utilization levels yielding adequate returns on investments, all with a view to providing an acceptable level of service to the customers. These strategic decisions are challenging from the point of view of a single XSP, especially when the XSP is a small to medium enterprise with little hold on its market share in a competitive environment. Errors in these decisions, both predictable and unpredictable, could cost the XSP significantly.

Consequently, there is a need in the art for mechanisms by which XSPs may maximize service performance to the customers and cache capacity utilizations at the same time. In particular, there is a need in the art by which XSPs may either buy additional capacity from other participants or sell any excess capacity to them as and when needed in real-time via a network of cache servers owned by the participants. Such a network of cache servers (equivalently proxy servers) owned, operated and utilizations coordinated through capacity trading by different XSPs may be referred to herein as a Capacity Provision Network (CPN). Note that a CPN may be differentiated from a CDN: while the focus of a CDN is replication of content from specifically contracted content providers, the focus of a CPN is caching of content as accessed by users in any random fashion from the world of content servers. Typically, a CPN may be based on capacity sharing arrangements among several service providers, and operated, as described further below, via a trading hub. In other words, a CDN services the supply-side of content distribution, whereas a CPN services the demand-side. Each XSP serves a local customer base, and the demand for cache capacity usually varies over time depending on the access behavior of the customers. A CPN trading mechanism would tend to alleviate the costs associated with errors in capacity planning.

### SUMMARY OF THE INVENTION

The aforementioned needs are addressed by the present invention. Accordingly, there is provided a method for trading cache capacity among network nodes (or equivalently XSPs). The method includes determining an arbitrage-free path in a network including at least one node having an excess of cache capacity and at least one node having an excess cache demand. The excess cache capacity is allocated through the arbitrage-free path to a node having an excess cache demand. A trading price is established for the excess cache capacity allocated.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a capacity provision network (CPN) system in accordance with the principles of the present invention;

FIG. 2 illustrates a high-level architecture for managing a CPN in accordance with an embodiment of the present invention;

FIG. 3 illustrates, in flow chart form, a market methodology in accordance with the present inventive principles which may be used in conjunction with the architecture of FIG. 2.

FIG. 4 illustrates, in flow chart form, a methodology for allocating capacity among trading XSPs in accordance with the present inventive principles which may be used in conjunction with the methodology of FIG. 3;

FIG. 5 illustrates, in flow chart form, a methodology for generating a prices in accordance with the present inventive principles which may be used in conjunction with the methodology of FIG. 3;

FIG. 6 illustrates, in flow chart form, an alternative market methodology in accordance with the present inventive principles which may be used in conjunction with the architecture of FIG. 2;

FIG. 7 illustrates, in high-level block diagram form, a CPN hub architecture in accordance with the present invention;

FIG. 8 illustrates a methodology for allocating cache capacity which may be used in conjunction with the hub architecture of FIG. 7; and

FIG. 9 illustrates, in block diagram form, a data processing system which may be used in conjunction with the methodologies incorporating the present inventive principles.

### DETAILED DESCRIPTION

In the following description, numerous specific details are set forth to provide a thorough understanding of the present invention. However, it will be obvious to those skilled in the art that the present invention may be practiced without such specific details. Refer now to the drawings wherein depicted elements are not necessarily shown to scale and wherein like or similar elements are designated by the same reference numeral through the several views.

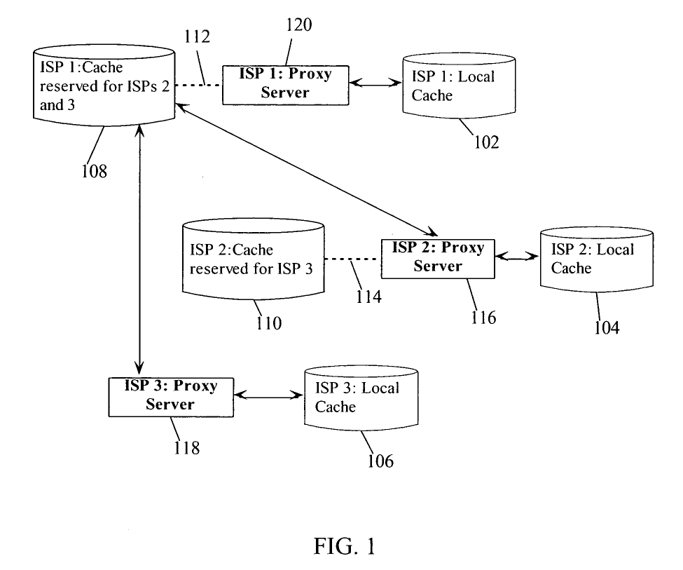

An invention that addresses the problem of caching capacity will now be described. Referring to FIG. 1, a CPN may be viewed as a collection of interconnected forward proxies. (Conversely, CDN is an assemblage of reverse proxies.) FIG. 1 illustrates a CPN 100 with three XSPs with cache trading agreements. In FIG. 1, each XSP sets aside a certain portion of the available cache for local use. (XSP 1 local cache 102, XSP 2 local cache 104 and XSP 3 local cache 106) The remaining capacity is traded. In this example, XSP 1 sells excess capacity (108) to XSPs 2 and 3, and XSP 2 sells a portion of its capacity (110) to XSP 3, and in some respects acts like an intermediary in a trilateral capacity trade. An intermediary may be an XSP that can both buy and sell capacity. As discussed hereinbelow, a discount factor may be associated with remote capacity, that is capacity available for local use. An intermediary may serve as a bridge for capacity trading among XSPs which may be beneficial to the XSPs when, for example, the discount factor is a decreasing and concave function of distance. The operation of an exchange of caching capacity through an intermediary and the gain in realized capacity resulting therefrom is described in detain in the U.S. Provisional Patent Application Ser. No. 60/424,939, entitled “Capacity Provision Networks: Systems For Internet Caching” which is hereby incorporated herein in its entirety by reference.

When traded, each XSP maintains a control link with the capacity it sells (such as control links 112 and 114), while allowing the buyers' proxies (proxy server 116 and proxy server 118, respectively) to access their allocated spaces for their respective use. When a certain cache capacity is traded to an XSP, the management of the contents of this cache is relegated to the buying XSP. As a result, the buyer determines what objects are to be cached and for how long, except that the seller's proxy maintains a link to the traded capacity resources and the buyer's proxy is enabled access to the cache via the seller's proxy. Here for example, link 112. (shown dashed) between the excess capacity of XSP 1 (108) and XSP 1 proxy server 120, and link 114 (shown dashed) between XSP 2 proxy server 116 and XSP 2's excess capacity (110). In the exemplary embodiment of FIG. 1, in some sense, the capacity bought from another XSP can be regarded as an extension of the local cache at the buyer's proxy, however located at a remote location. Each trade may be bound in time, and each trade may occur in different time windows.

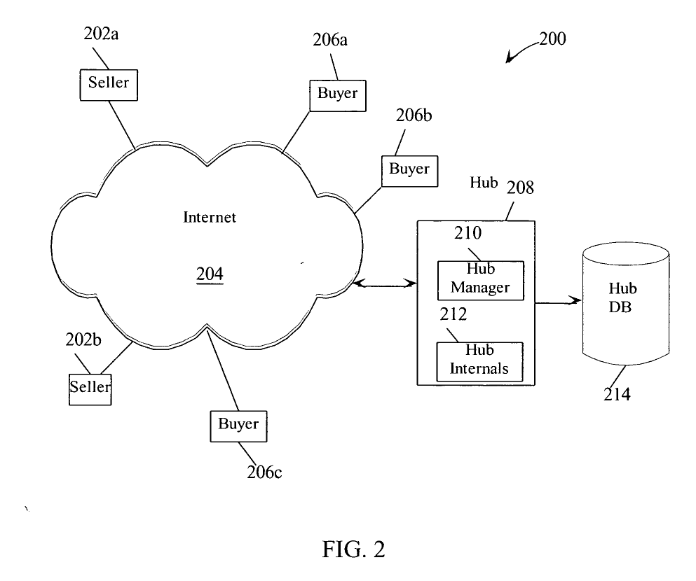

Refer now to FIG. 2 illustrating a high-level diagram of a Capacity Provision Network (CPN) architecture 200 in accordance with an embodiment of the present invention. A plurality of network-connected sellers 202a, 202b (collectively, “sellers 202”) represent XSPs having excess caching capacity that may be made available across the network 204 which, without loss of generality may be a “network of networks,” i.e. the Internet. Conversely, buyers 206a, 206b and 206c (collectively, “buyers 206”) represent network-connected XSPs with an excess of cache demand.

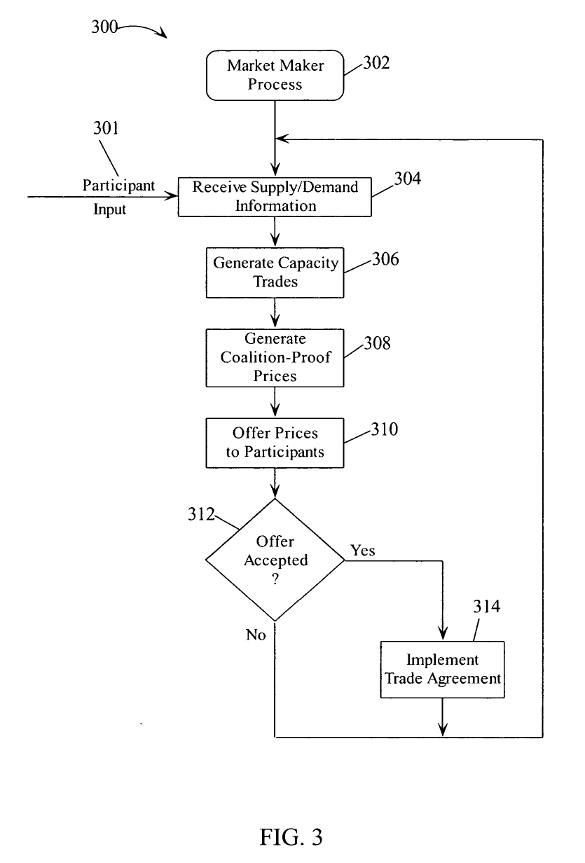

Hub 208 provides mechanisms to match the exchange of the excess capacity of sellers 202 and buyers 206. These mechanisms may be included in hub manager 210 and hub internals 212, described further hereinbelow in conjunction with FIGS. 3-7. Hub server 208 also may maintain a hub database 214 for storing CPN participant (sellers/buyers) profile information, also discussed further hereinbelow.

A methodology 300 for making a market in Web caching capacity in accordance with an embodiment of the present invention is illustrated in flow chart form in FIG. 3. The flow charts provided herein are not necessarily indicative of the serialization of operations being performed in an embodiment of the present invention. Steps disclosed within these flow charts may be performed in parallel. The flow charts represent those considerations that may be performed to effect an exchange of caching capacity among XSPs. It is further noted that the order presented is illustrative and does not necessarily imply that the steps must be performed in order shown.

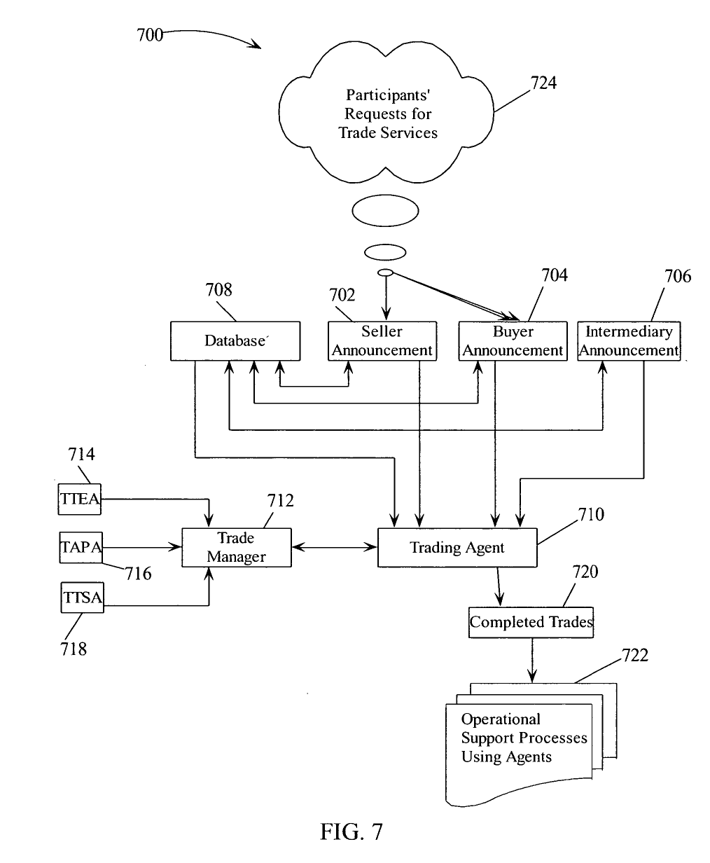

The participating XSPs provide information to the CPN hub (equivalently, for the present purpose, market maker); the information includes the available capacity, demand and the penalty costs. As discussed further hereinbelow in conjunction with FIG. 7, the hub monitors network delays and computes discount factors based on the delay information. (This information may be stored by the hub in a participant profile database along with other data that may be used in an alternative embodiment of the present invention.) Using this information, the market maker may allocate cache capacity among participants with an excess of capacity as providers to XSPs with an excess of cache demand. Additionally, as described in conjunction with FIG. 1, a subset of participating XSPs may serve as intermediaries, consuming excess cache capacity of one set of XSPs and selling caching capacity to another set.

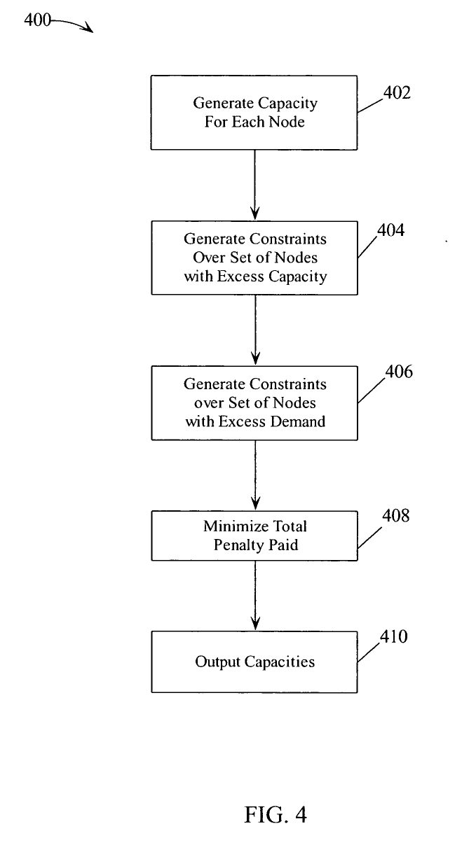

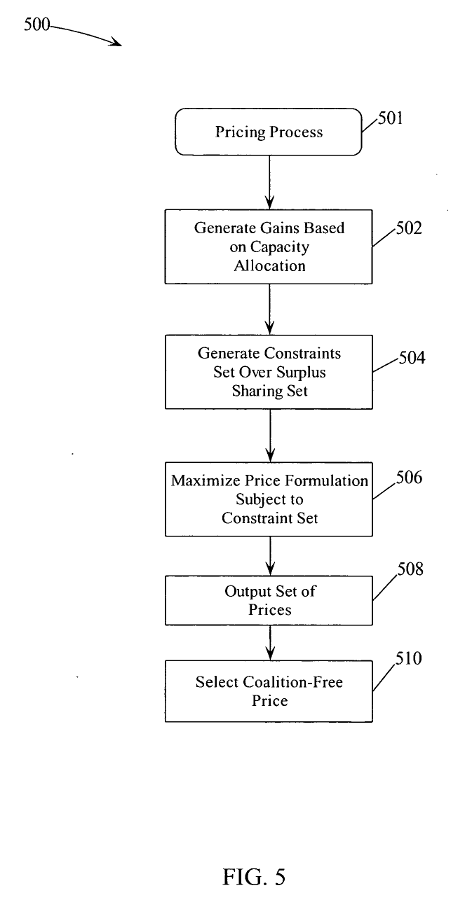

In step 304, capacity trades, based on the information received in step 302 are generated, and in step 306, the capacity trades are used to generate coalition-proof prices. A methodology for generating capacity trades that may be used in step 304 is described in conjunction with FIG. 4. A process for generating coalition-proof prices that may be used in step 306 is described in conjunction with FIG. 5. As discussed below, coalition-proof prices are such that no subset of XSPs is better off by not participating in the CPN market and striking exchanges of capacity among themselves.

In step 308, the prices generated in step 306 are offered to the participants. If the participants do not accept, step 310, process 300 returns to step 302. (Process 300 may be adapted to a continuously operating market in which capacity trading is effected by matching the excess capacities and excess demands at selected intervals of time.) If, in step 310, the participants accept the offered prices (which, as discussed below include a market maker's commission), then in step 312, the trade agreement is implemented. In an alternative embodiment, the participants may be obligated to execute the trade agreement, for example by contract with the entity that operates the hub. In other words, in such an embodiment, participating XSPs would be bound to the coalition-free price and the exchange of caching capacity. Also, step 308 would be bypassed, or omitted.

Refer now to FIG. 4 illustrating, in flowchart form, process 400 for allocating caching capacity among XSP traders. Process 400 may be used, for example, to perform step 304, in process 300 for exchanging cache capacity illustrated in FIG. 3.

In step 402, the capacity for each node (equivalently, XSP) is generated. For the ith node, this value, denoted Cᵢ, may be represented as the aggregate of its local capacity, that is the portion of the ith node's own capacity reserved for its own use, denoted Cᵢᵢ and the capacity available from other nodes, denoted Cⱼᵢ (the capacity made available to node i by node j). Thus,

$${C}_{i} = {\sum }_{j = 1}^{N} {C}_{ji} ∀ i , i = 1 , … N . \qquad ( 1 )$$

Because of network bandwidth limitations, remotely available capacity may be discounted in value by a particular XSP. Therefore, the utility of the capacity available from node j may be reduced by a discount factor δᵢⱼ≦1, with δᵢᵢ=1. (The determination of the δᵢⱼ is discussed below in conjunction with FIG. 7.) Thus, the effective capacity available to the ith node may be represented by

$${\sum }_{j = 1}^{N} {δ}_{ji} {C}_{ji} ,$$

where the number of nodes participating in the capacity trading market is N. (Note that nodes with no excess capacity or with excess demand, have Cⱼᵢ=0 for j≠i.)

In step 404, a constraint over the set of nodes with excess capacity is imposed. Because capacity that is provided to other nodes is discounted, all XSPs belonging to E should not face a shortfall. Denoting the set of nodes with excess capacity by E (⊂N), that is, E={i|Cᵢ≦Dᵢ} where Dᵢ denotes the ith node's demand for cache capacity, and the set of nodes with excess demand by F (⊂N), that is, F={i|Cᵢ<Dᵢ}, then the constraint in step 404 becomes:

$${\sum }_{j = 1}^{N} {δ}_{ji} {C}_{ji} \geq {D}_{i} , ∀ i ∈ E . \qquad ( 2 )$$

Likewise, for nodes in F, the effective capacity that is supplied should not exceed that which is required. In step 406 a constraint over the set of nodes with excess demand is imposed:

$${\sum }_{j = 1}^{N} {δ}_{ji} {C}_{ji} \leq {D}_{i} , ∀ i ∈ F . \qquad ( 3 )$$

A node that has insufficient cache capacity to meet demand may suffer a pecuniary penalty. This may be represented by a monetary payment or discount to subscribers base on a contracted quality of service (QoS). Alternatively, an XSP with insufficient caching capacity may experience a churn rate of its subscribers that may be reflected in a reduction in its revenue. In step 408, the penalty paid by the nodes with excess demand is minimized. Denoting the penalty paid by the ith XSP by bᵢ, this aggregate penalty across trading XSPs faced with a deficit in cache capacity is:

$${\sum }_{j = 1}^{N} {b}_{i} ( {D}_{i} - {δ}_{ji} {C}_{ji} ) , ∀ i ∈ F . \qquad ( 4 )$$

The penalty in Equation (4) may be minimized in step 408 subject to the constraints in Equations (1)-(3) above. Step 408 represents a linear programing task, techniques for which are known in the art. This minimization, generates a set of capacities Cⱼᵢ that allocate the excess caching capacity of the participating XSPs in the set E among the XSPs with excess demand. In step 410, the capacities generated in step 408, which are denoted C*ⱼᵢ are output. These may be used in conjunction with the methodology in FIG. 5 to generate a trade price for the caching capacity exchanged among the XSPs. A node i may be said to be pure supply if

$${\sum }_{j , j \neq i}^{N} {C}_{ji}^{*} = 0 and {\sum }_{j , j \neq i}^{N} {C}_{ij}^{*} > 0.$$

Similarly a node i may be referred to as a pure demand node if

$${\sum }_{j , j \neq i}^{N} {C}_{ji}^{*} > 0 and {\sum }_{j , j \neq i}^{N} {C}_{ij}^{*} > 0 ,$$

and a node i said to be an intermediary if

$${\sum }_{j , j \neq i}^{N} {C}_{ji}^{*} > 0 and {\sum }_{j , j \neq i}^{N} {C}_{ij}^{*} > 0.$$

Referring now to FIG. 5, there is shown, in flowchart form, process 500 for pricing the exchange of cache capacity among XSPs. A price structure in accordance with the methodology of process 500 may be such that each participating XSP realizes gains from participating in the CPN.

In step 502, the gains are generated. The gains may be based on the capacities output in step 410 of FIG. 4. For a supply node, the gain is the difference between the revenue from selling its excess capacity and its cost of acquiring its caching capacity. Denoting the price for a unit of caching capacity in the market by Pᵢ (which is to be determined), the gain to a supply node may be represented by:

$${g}_{i} = ( {P}_{i} {\sum }_{i \neq j} {C}_{ij}^{*} ) - {\sum }_{i \neq j} {P}_{j} {C}_{ij}^{*} ∀ i ∈ E . \qquad ( 5 )$$

The gain to a demand node arises from the its cost savings. If a demand node i does not participate in the market, the penalty it pays is bᵢ(Dᵢ−Cᵢ). The net gain from participating for a demand node is

$${g}_{i} = ( {D}_{i} - {C}_{i} ) {b}_{i} - ( {D}_{i} {\sum }_{j} {δ}_{ji} {C}_{ji}^{*} ) {b}_{i} + \\ ( {P}_{i} {\sum }_{j \neq i} {C}_{ij}^{*} ) - {\sum }_{i \neq j} {P}_{j} {C}_{ji}^{*} ∀ i ∈ F . \qquad ( 6 )$$

In step 504, a constraint set over the set of gains is imposed. The constraints may be imposed such that no subset of XSPs is better off by not participating in the CPN market and striking exchanges of capacity among themselves. A set of gains, gᵢ satisfying the condition that no such subset of XSPs exists may be referred to as coalition proof The set of coalition-proof gains may be denoted by Q. Denoting the difference between the total penalty paid without trading and the total penalty paid with trading using the capacities from process 400, FIG. 4, for an arbitrary subset, S⊂N of XSPs by G_{S}, the constraint may be given by:

$${G}_{s} \leq {\sum }_{i ∈ S} {g}_{i} , ∀ S ⊆ N . \qquad ( 7 )$$

This constraint is equivalent to the condition {g|gᵢ∈Q,i=1,2, . . . N}.

The market maker, as a profit-seeking entity, may charge the participant XSPs a commission. Denoting the commission per unit of gain to the ith participant by wᵢ, a price
formulation may be defined as the scalar product of the commissions and the gains:

$${\sum }_{i = 1}^{N} {w}_{i} {g}_{i} .$$

In step 506, the price formulation is maximized subject to the constraint, Equation (7), imposed in step 504. This is also a linear programming task. The sets of coalition-free prices, denoted Pᵢ*, resulting from step 506 are output in step 508. In step 510, a MSRP which may be used in step 308 of FIG. 3 is selected from the sets of Pᵢ*.

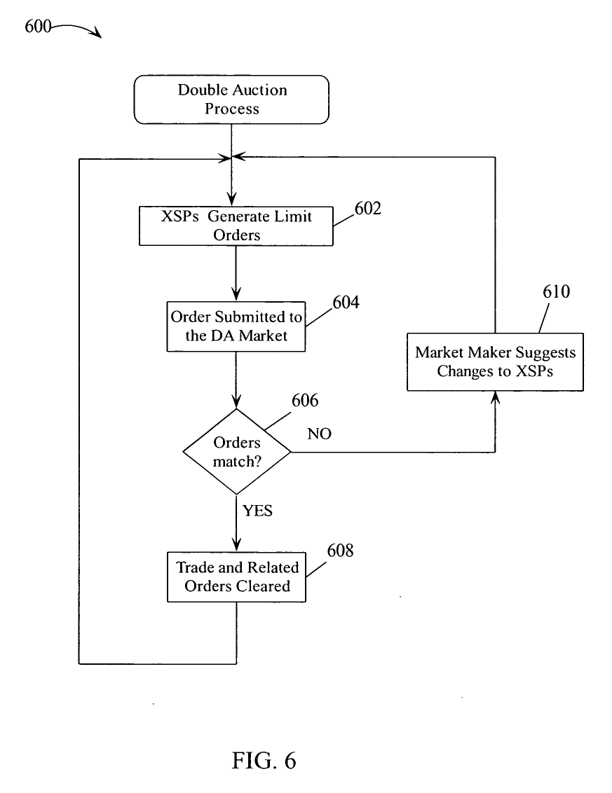

FIG. 6 illustrates a process 600 for exchanging caching capacity in a double auction in accordance with an embodiment of the present invention. In step 602, XSPs with capacity to trade and XSPs with excess demand enter limit orders. A limit order may be in the form of a vector; in which case a limit order from the ith XSP may be represented by (zᵢ, ηᵢ), where zᵢ is a bundle presented in a vector of size N+1, assuming without loss of generality a market with N XSPs participating. The bundle, zᵢ represents the amount of capacity the ith XSP wants to “acquire” from each of the other XSPs, and ηᵢ>0 is a limit quantity, zᵢ=[z₁ᵢ, z₂ᵢ, . . . z_{Ni}, Pᵢ], where zⱼᵢ is the amount of capacity the ith XSP wants from the jth XSP in each unit of the bundle. (A negative zᵢⱼ indicates that the ith XSP has capacity to send to the jth XSP, a zero value indicates there is no network connection between these XSPs.) The value pᵢ is the minimum price the ith XSP charges for this unit bundle (for a negative pᵢ, the absolute value of pᵢ is the maximum price the ith XSP would pay for this unit bundle). In step 604, the each XSP submits its order into the market.

The market maker matches orders, step 606 by determining a solution y=[y₁, y₂, . . . y_{N}]^{T}, where yᵢ is the amount of unit bundles for the ith XSP with 0≦yᵢ≦ηᵢ, such that (in vector notation)
[p₁,p₂ . . . p_{N}]y≦0
and zⱼᵢyᵢ+zᵢⱼyⱼ≦0 for any i, j such that j≠i
   The first condition means that the sum of all prices paid by XSPs should be larger than the sum of all prices demanded by XSPs. The other set of conditions say that between any two pair of XSPs, supply should be equal to or larger than demand. If a solution is found, (“Y” branch of step 606), trade orders are cleared, step 608, and the XSPs that are involved in the trades accordingly reduce their remaining local cache volume. Process 600 returns to step 602.

If the market maker fails to find a solution y (“No” branch, step 606), the market maker submits changes to the XSPs, step 610. When an XSP submits a limit order that only demands (supplies) capacity, the market maker knows that this XSP is a pure demand (supply) node. Likewise, the market maker also knows which XSPs are intermediaries. Therefore the market maker is informed about directions for trading flows. The market maker may use the capacity allocation methodology discussed hereinabove to provide suggested prices to the XSPs whereby the XSPs may adjust the limit orders accordingly, and process 600 returns to step 602.

Refer now to FIG. 7 illustrating CPN hub architecture 700. A seller wishing to trade excess capacity enters a seller's announcement 702 including the capacity available. (C_{A}), start time (S_{A}), end time (E_{A}) and the location where the capacity is available (L_{A}). Similarly, a node with excess demand enters a buyer's announcement 704. A seller's announcement may include the amount of capacity needed (C_{N}), start time (S_{N}), end time (E_{N}) and the location where the capacity is needed (L_{N}). As previously discussed, a node (or XSP) may serve as an intermediary, acquiring excess capacity from one or more sellers and supplying capacity to a buyer. An intermediary enters an intermediary's announcement 706 which may include the amount of capacity tradable through him, (C₁), start time (S₁), end time (E₁) and the location where the capacity is available (L₁). This information may be stored in a database 708. (Database 708 may constitute an embodiment of hub database 214, FIG. 2.) Additionally, the database may include additional trading participant profile data, for example, the location of their servers, maximum capacity available and network access path (NCP) for servers. The NCP can be specified at a high level in terms of server, local net, regional net and backbone. This NCP is exemplary and the granularity (level of detail) of this specification may be further refined in alternative embodiments of the present invention. From this data, a topological map of the Internet segments connecting all the servers of the market participants according to their network access paths may be constructed and stored in the database.

The announcement data is provided to trading agent 710, which as described further hereinbelow may use the methodologies for generating capacities and prices, discussed in conjunction with FIGS. 3-5 above. Trading agent 710 may operate in conjunction with trade manager 712 to allocate cache capacity among selling and buying XSPs. In particular, trade manager 712 may employ a topological transfer efficiency algorithm (TTEA) 714 to generate the transfer efficiency δᵢⱼ, given a pair of locations for a trade, LA and L_{N}. Two types of data may be used by the TTEA. One type, which may be referred to as static data originates from the profiles of two trading parties (such as their locations, line speeds etc.). The other type, which may be referred to as dynamic data is generated from a traffic analysis that continuously assess network traffic conditions through traces and pinging various routers and servers in the network, collect statistics and make projections on future traffic conditions. These projections and the static data would together provide the inputs for TTEA, which would then determine the value of δᵢⱼ for a given trade option.

The performance of any remote capacity can be negatively affected by the delay between that XSP and its trading partner supplying the remote caching capacity. The more remote the capacity, the more likely that retrieving data from it could be delayed. Representing the average delay experienced by a customer of an XSP in accessing content from a remote XSP cache be tᵣ, representing the average delay fetching from local cache by t_{c}, and the average delay experienced in the absence of caching as (retrieving the content directly from its server) t₀, then one unit of remote cache only equals (t₀−tᵣ)/(t₀−t_{c}) units of local cache, which implies that remote cache is discounted by a factor of (t₀−tᵣ)/(t₀−t_{c}). Thus, the discount factor between a pair of XSPs, say the ith and jth XSPs may be determined as δ_{i,j}=(t₀−t_{i,j})/(t₀−t_{c}) where the average delay between these two XSPs is t_{i,j}. (The delay, t_{i,j}=t_{c}.) Note that the δᵢⱼ could, in one embodiment, change periodically, or alternatively, in another embodiment, continuously. These may be susceptible to Internet behaviors such as surges, low and high activities, etc. The frequency at which the δᵢⱼ are recalculated is related to the volatility of Internet traffic and congestion. The frequency of recalculation may be adaptively adjusted so that network delay remains largely unchanged between any two recalculations. For example, the interval between recalculations may be adjusted such that the fractional change of network delays is less than or equal to a preselected value, say ten percent (10%). Note that this value is exemplary and that other values may be selected in alternative embodiments.

Additionally, trade manager 712 may, via topological arbitrage-free path-finder algorithm (TAPA) 716 analyze alternative paths between a buyer and seller. An arbitrage-free path between a buyer and seller is the one that yields the largest product of discount factors along the path, relative to all other paths between them. For example, along the path between a seller and a buyer, there could be several intermediaries. There could also be several paths through these intermediaries. Using TAPA 716, trade manager 712 checks all these potential paths and determine the arbitrage-free path between the two. Given a set of buyers, sellers and intermediaries, their requirements and availability schedules and the TAPA output between every pair of buyers-sellers, a topological trade scheduler algorithm (TTSA) 718 determines the optimal schedule of trades among them. The TTSA solution will be arbitrage-free.

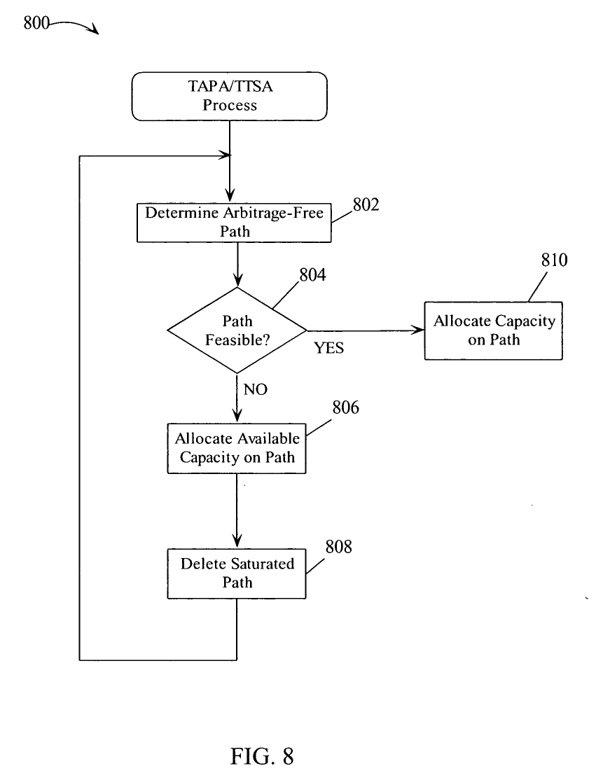

FIG. 8 illustrates a process 800 which may be used by TAPA 716 and TTSA 718 to allocate capacity among trading XSPs. In step 802, the arbitrage-free path in the network of trading XSPs is determined. As previously stated this path has the largest product of discount factors. This problem can be transformed into an equivalent “shortest-path problem” in a network, and techniques for solving such problems are known in the art. One such methodology which may be used in step 802 is Djikstra's algorithm, which is known to those of ordinary skill in the art in operations research. Step 802 may be embodied in TAPA 716, FIG. 7.

In step 804 it is determined if the path determined in step 802 is feasible. That is, along the arbitrage-free path, the excess capacity available from selling XSPs may not be sufficient to satisfy the demand of the buying XSP. If this pertains, then the path may be said to be “infeasible.” In step 806, the available capacity on this path is allocated, and in step 808, this “saturated” path is deleted from the network of trading XSPs, and process 800 returns to step 802. Conversely, if, in step 804, the arbitrage-free path from step 802 is feasible, the capacity on that path is allocated to the buying XSP, step 810. Steps 804-810 may be embodied in TTSA 718, FIG. 7. Note that, the capacity allocation methodology of FIGS. 3-5 performs the joint functionality of TAPA 716 and TTSA 718, and may be used in an alternative embodiment thereof. Returning to FIG. 7, trading agent 710 outputs completed trades 720. (TTEA 714, TAPA 716, and TTSA 718 may be included in hub internals 210, FIG. 2.) Trades are supported by operational support agents 722 deployed on the XSPs. The operational support agents implement the contracts established by the trades in conjunction with the participating XSPs. The CPN hub, such as hub 208, FIG. 2, would provide agent software to the XSPs that would be installed and run on their respective proxies. For example if an XSP (such as XSP 3, FIG. 1) buys capacity from two other XSPs (XSP 1 and XSP 2, FIG. 1), the agent at the buying XSP would coordinate with the other two agents for location management, pruning and content replacement operations. (Pruning refers to the locating of a requested cached Web object in a cache hierarchy.) The agents may be developed as a Web service, and may be implemented with the parametric choices of the participating XSPs at run-time.

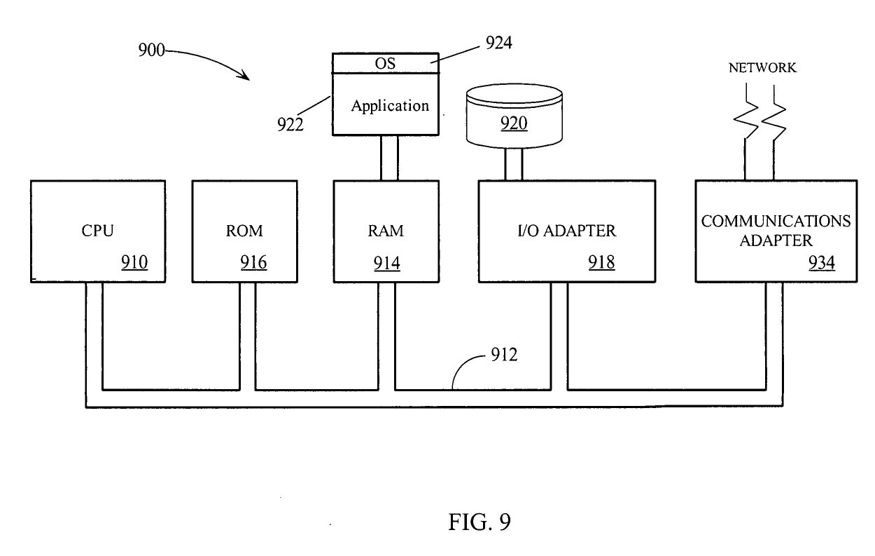

FIG. 9 illustrates an exemplary hardware configuration of data processing system 900 in accordance with the subject invention. The system, in conjunction with the methodologies illustrated in FIGS. 3-6 may be used, to perform CPN hub services as described hereinabove, in accordance with the present inventive principles. Data processing system 900 includes central processing unit (CPU) 910, such as a conventional microprocessor, and a number of other units interconnected via system bus 912. Data processing system 900 also includes random access memory (RAM) 914, read only memory (ROM) 916 and input/output (I/O) adapter 918 for connecting peripheral devices such as disk units 920 to bus 912. System 900 also includes communication adapter 934 for connecting data processing system 900 to a data processing network, such as Internet 204, FIG. 2, enabling the system to communicate with other systems. CPU 910 may include other circuitry not shown herein, which will include circuitry commonly found within a microprocessor, e.g. execution units, bus interface units, arithmetic logic units, etc. CPU 910 may also reside on a single integrated circuit.

Preferred implementations of the invention include implementations as a computer system programmed to execute the method or methods described herein, and as a computer program product. According to the computer system implementation, sets of instructions, shown as application 922, for executing the method or methods are resident in the random access memory 914 of one or more computer systems configured generally as described above. These sets of instructions, in conjunction with system components that execute them, such as operating system (OS) 924, may be used to perform CPN hub operations as described hereinabove. Until required by the computer system, the set of instructions may be stored as a computer program product in another computer memory, for example, in disk drive 920 (which may include a removable memory such as an optical disk or floppy disk for eventual use in the disk drive 920). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

1. A method for trading cache capacity comprising:
(a) determining an arbitrage-free path in a network comprising at least one node having an excess of cache capacity and at least one node having an excess cache demand;
(b) allocating said excess cache capacity on said arbitrage-free path to a node of said at least one node having an excess cache demand; and
(c) establishing a trading price for said excess cache capacity allocated in step (b).

2. The method of claim 1 further comprising:
(d) determining if a cache capacity available on said arbitrage-free path is sufficient to satisfy said excess cache demand; and
(e) if the cache capacity available on said arbitrage-free path is insufficient:
(1) deleting said arbitrage-free path from said network; and
(2) repeating steps (a), (b) and (c).

3. The method of claim 1 wherein steps (a) and (b) comprise solving a linear programming problem.

4. The method of claim 3 wherein the linear programming problem includes:
(c) generating a first constraint set over a first set of nodes having excess cache capacity; and
(d) generating a second constraint set over a second set of nodes having excess cache demand; and
(e) minimizing a total penalty paid subject to said first and second constraint sets.

5. The method of claim 4 wherein:
the first constraint set comprises:
$${\sum }_{j = 1}^{N} {δ}_{ji} {C}_{ji} \geq {D}_{i} , ∀ i ∈ E ,$$
where E comprises the set of nodes with excess capacity and Dᵢ comprises an ith node's demand for cache capacity and Cⱼᵢ comprises the capacity made available to node i by node j;
the second constraint set comprises:
$${\sum }_{j = 1}^{N} {δ}_{ji} {C}_{ji} \leq {D}_{i} , ∀ i ∈ F ,$$
wherein Cⱼᵢ comprises a capacity made available to node i by node j, F comprises the set of nodes with excess demand, wherein a total number of nodes is N, and wherein the δᵢⱼ comprise a set of discount factors between an ith and jth node, i, j=1,2, . . . ,N.

6. The method of claim 5 further comprising generating said set of discount factors in response to path delays between each of said ith and jth node, i, j=1,2, . . . ,N.

7. The method of claim 6 wherein said discount factors are generated dynamically.

8. The method of claim 4 wherein a penalty function minimized in said minimizing step comprises
$${\sum }_{j = 1}^{N} {b}_{i} ( {D}_{i} - {δ}_{ji} {C}_{ji} ) , ∀ i ∈ F ,$$
wherein Dᵢ comprises an ith node's demand for cache capacity and bᵢ comprises a penalty paid by an ith node, wherein F comprises the set of nodes with excess demand, and a total number of nodes is N, and wherein the δᵢⱼ comprise a set of discount factors between an ith and jth node, i, j=1,2, . . . ,N.

9. The method of claim 1 wherein step (c) comprises maximizing a price formulation subject to a constraint and wherein said constraint comprises a condition that a gain for each node comprises a coalition-proof gain.

10. The method of claim 9 wherein said constraint comprises
$${G}_{s} \leq {\sum }_{i ∈ S} {g}_{i} , ∀ S ⊆ N ,$$
wherein G_{S} comprises a difference between a total penalty paid without trading and a total penalty paid with trading, said penalties determined in response to a capacity allocation from steps (a) and (b), and gᵢ comprises a net gain of an ith node, ∀∈F, and wherein F comprises the set of nodes with excess demand.

11. The method of claim 9 wherein said price formulation comprises
$${\sum }_{i = 1}^{N} {w}_{i} {g}_{i} , {g}_{i}$$
comprises a net gain of an ith node, ∀∈F, and wherein F comprises the set of nodes with excess demand and wᵢ comprises a commission charged the ith node, and a total number of nodes is N.

12. The method of claim 9 wherein said gain comprises
$${g}_{i} = ( {D}_{i} - {C}_{i} ) {b}_{i} - ( {D}_{i} - {\sum }_{j} {δ}_{ji} {C}_{ji}^{*} ) {b}_{i} + ( {P}_{i} {\sum }_{j \neq i} {C}_{ij}^{*} ) - \\ {\sum }_{i \neq j} {P}_{j} {C}_{ji}^{*} ∀ i ∈ F ,$$
wherein F comprises the set of nodes with excess demand, wherein Pᵢ comprises a unit price of caching capacity at an ith node, Dᵢ comprises an ith node's demand for cache capacity, bᵢ comprises the penalty paid by the ith node, C*ᵢⱼ comprises a capacity made available to node i by node j in response to an allocation from steps (a) and (b), and Cᵢ comprises an aggregate cache capacity at the ith node.

13. The method of claim 1 wherein said price comprises a suggested price established by a market maker in a double auction market.

14. The method of claim 1 wherein said price comprises a trading price in a trade between said least one node having an excess of cache capacity and said at least one node having an excess cache demand executed by a market maker.

15. A data processing system for trading cache capacity comprising:
(a) circuitry operable for determining an arbitrage-free path in a network comprising at least one node having an excess of cache capacity and at least one node having an excess cache demand;
(b) circuitry operable for allocating said excess cache capacity on said arbitrage-free path to a node of said at least one node having an excess cache demand; and
(c) circuitry operable for establishing a trading price for said excess cache capacity allocated by (b).

16. The data processing system of claim 15 further comprising:
(d) circuitry operable for determining if a cache capacity available on said arbitrage-free path is sufficient to satisfy said excess cache demand; and
(e) circuitry operable for, if the cache capacity available on said arbitrage-free path is insufficient:
(1) deleting said arbitrage-free path from said network; and
(2) repeating operations by (a), (b) and (c).

17. The data processing system of claim 15 wherein the circuitry of (a) and (b) includes:
(c) circuitry operable for generating a first constraint set over a first set of nodes having excess cache capacity; and
(d) circuitry operable for generating a second constraint set over a second set of nodes having excess cache demand; and
(e) circuitry operable for minimizing a total penalty paid subject to said first and second constraint sets.

18. The data processing system of claim 17 wherein:
the first constraint set comprises:
$${\sum }_{j = 1}^{N} {δ}_{ji} {C}_{ji} \geq {D}_{i} , ∀ i ∈ E ,$$
where E comprises the set of nodes with excess capacity and Dᵢ comprises an ith node's demand for cache capacity and Cᵢⱼ comprises the capacity made available to node i by node j; and
the second constraint set comprises:
$${\sum }_{j = 1}^{N} {δ}_{ji} {C}_{ji} \leq {D}_{i} , ∀ i ∈ F ,$$
wherein Cⱼᵢ comprises a capacity made available to node i by node j, F comprises the set of nodes with excess demand, wherein a total number of nodes is N, and wherein the δᵢⱼ comprise a set of discount factors between an ith and jth node, i, j=1,2, . . . ,N.

19. The data processing system of claim 17 further comprising circuitry operable for generating said set of discount factors in response to path delays between each of said ith and jth node, i, j=1,2, . . . ,N.

20. The data processing system of claim 17 wherein a penalty function minimized by said circuitry operable for minimizing comprises:
$${\sum }_{j = 1}^{N} {b}_{i} ( {D}_{i} - {δ}_{ji} {C}_{ji} ) , ∀ i ∈ F ,$$
wherein Dᵢ comprises an ith node's demand for cache capacity and bᵢ comprises a penalty paid by an ith node, wherein F comprises the set of nodes with excess demand, and a total number of nodes is N, and wherein the δᵢⱼ comprise a set of discount factors between an ith and jth node, i, j=1,2, . . . ,N.

21. The data processing system of claim 15 wherein said circuitry in (c) comprises circuitry operable for maximizing a price formulation subject to a constraint and wherein said constraint comprises a condition that a gain for each node comprises a coalition-proof gain.

22. The data processing system of claim 21 wherein said constraint comprises
$${G}_{s} \leq {\sum }_{i ∈ S} {g}_{i} , ∀ S ⊆ N ,$$
wherein G_{S} comprises a difference between a total penalty paid without trading and a total penalty paid with trading, said penalties determined in response to a capacity allocation from steps (a) and (b), and gᵢ comprises a net gain of an ith node, ∀∈F, and wherein F comprises the set of nodes with excess demand.

23. The data processing system of claim 21 wherein said price formulation comprises
$${\sum }_{i = 1}^{N} {w}_{i} {g}_{i} ,$$
gᵢ comprises a net gain of an ith node, ∀∈F, and wherein F comprises the set of nodes with excess demand and wᵢ comprises a commission charged the ith node, and a total number of nodes is N.

24. The data processing system of claim 21 wherein said gain comprises
$${g}_{i} = ( {D}_{i} - {C}_{i} ) {b}_{i} - ( {D}_{i} - {\sum }_{j} {δ}_{ji} {C}_{ji}^{*} ) {b}_{i} + ( {P}_{i} {\sum }_{j \neq 1} {C}_{ij}^{*} ) - {\sum }_{i \neq j} {P}_{j} {C}_{ji}^{*} ∀ i ∈ F ,$$
wherein F comprises the set of nodes with excess demand, wherein Pᵢ comprises a unit price of caching capacity at an ith node, Dᵢ comprises an ith node's demand for cache capacity, bᵢ comprises the penalty paid by the ith node, C*ⱼᵢ comprises a capacity made available to node i by node j in response to an allocation from steps (a) and (b), and Cᵢ comprises an aggregate cache capacity at the ith node.

25. The data processing system of claim 15 wherein said price comprises a trading price in a trade between said least one node having an excess of cache capacity and said at least one node having an excess cache demand executed by a market maker.

26. A computer program product embodied in a tangible storage medium comprising programming instructions for trading cache capacity, the programming including instructions for:
(a) determining an arbitrage-free path in a network comprising at least one node having an excess of cache capacity and at least one node having an excess cache demand;
(b) allocating said excess cache capacity on said arbitrage-free path to a node of said at least one node having an excess cache demand; and
(c) establishing a trading price for said excess cache capacity allocated in step (b).

27. The computer program product of claim 26 wherein (a) and (b) include:
(c) generating a first constraint set over a first set of nodes having excess cache capacity; and
(d) generating a second constraint set over a second set of nodes having excess cache demand; and
(e) minimizing a total penalty paid subject to said first and second constraint sets.

28. The computer program product of claim 26 further comprising programming instructions for:
(d) determining if a cache capacity available on said arbitrage-free path is sufficient to satisfy said excess cache demand; and
(e) if the cache capacity available on said arbitrage-free path is insufficient:
(1) deleting said arbitrage-free path from said network; and
(2) repeating (a), (b) and (c).
